(19) United States
(12) Patent Application Publication
(10) Pub. No.: US 2025/0282140 A1
(43) Pub. Date: Sep. 11, 2025

(54) INKJET PRINTING APPARATUS

(71) Applicant: SCREEN Holdings Co., Ltd., Kyoto (JP)

(72) Inventor: Hideaki ONISHI, Kyoto-shi (JP)

(21) Appl. No.: 19/023,756

(22) Filed: Jan. 16, 2025

(30) Foreign Application Priority Data
Mar. 11, 2024 (JP) 2024-037588

(51) Int. Cl. B41J 2/165; B41J 2/045; B41J 2/175

(52) U.S. Cl. CPC B41J 2/16511; B41J 2/0451; B41J 2/04581; B41J 2/17596

(57) ABSTRACT

The input unit receives a first command for switching a first ink discharge surface from a capped state to a decapped state and outputs a first input signal, and receives a second command for switching a second ink discharge surface from a capped state to a decapped state and outputs a second input signal. The control unit can perform step a) of switching the first ink discharge surface from a capped state to a decapped state when the first input signal is received and it is detected that a first head unit has moved from a first driving position to a first maintenance position, and step b) of switching the second ink discharge surface from a capped state to a decapped state when the second input signal is received and it is detected that a second head unit has moved from a second driving position to a second maintenance position.

### RELATED APPLICATIONS

This application claims the benefit of Japanese application No. 2024-037588, filed on 11 Mar. 2024, the disclosure of which is incorporated by reference herein.

### BACKGROUND OF THE INVENTION

### Field of the Invention

The present invention relates to an inkjet printing apparatus that performs printing on a printing medium such as paper by an inkjet method.

### Description of the Background Art

Conventionally, in an inkjet printing apparatus, various kinds of maintenance are performed in order to prevent clogging of a nozzle that discharges ink. For example, in order to prevent a nozzle from being dried during stop of printing, the nozzle is covered with a cap, whereby an ink discharge surface including the nozzle is isolated and enclosed from an outside atmosphere. Such a method of performing maintenance of a nozzle is described in, for example, Japanese Patent Application Laid-Open No. 2014-136396.

Japanese Patent Application Laid-Open No. 2014-136396 discloses a maintenance unit (9) for performing maintenance of an image forming apparatus. The maintenance unit (9) includes a cap (91) for capping a nozzle surface (124), a wiper member (94) for wiping the nozzle surface (124), a suction pump (97) connected to the cap (91), and a waste tank (98) connected to the suction pump (97) (paragraphs and [0039]). Meanwhile, the maintenance unit (9) is provided so as to be movable between a maintenance position where the nozzle surface (124) is capped with the cap (91) and a receding position where the maintenance unit (9) recedes from the maintenance position (paragraph [0043], FIG. 5(a), and FIG. 5(b)).

In recent years, an apparatus that performs an operation (capping) of covering an ink discharge surface including a nozzle with a cap and isolating and enclosing the ink discharge surface from an outside atmosphere, and an operation (decapping) of separating the cap from the ink discharge surface and exposing the ink discharge surface to the outside atmosphere, in response to an input operation performed on an input screen by an operator or the like, is used in many cases. In the case of such an apparatus, the operator designates a head to be an object on the input screen, and inputs an instruction for “capping” or “decapping”, to thereby automatically perform capping of the designated head.

In this regard, in order to prevent the nozzle from being dried during stop of printing, it is preferred to enclose the ink discharge surface including the nozzle with the cap as long as possible while the nozzle is not subjected to any process such as wiping. That is, it is preferred to keep the ink discharge surface in a “capped state” as long as possible while the nozzle is not subjected to any process such as wiping. To this end, it is preferred that the operator designate a head including the nozzle and input an instruction for “decapping” on the input screen immediately before wiping or the like of the nozzle. That is, it is preferred that the operator designate a head and input an instruction for “decapping” on the input screen. However, this necessitates a time and effort of the operator appearing in person in front of the input screen and performing an input operation for each change of a head to be subjected to maintenance, increasing a burden on the operator.

### SUMMARY OF THE INVENTION

It is an object of the present invention to provide a technology that can reduce a burden on an operator while keeping an ink discharge surface including a nozzle in a capped state as long as possible in sequentially performing maintenance of a plurality of heads including a plurality of nozzles.

To solve the above-described problem, the first invention of the present application is directed to an inkjet printing apparatus that performs printing on a printing medium by an inkjet method and includes an apparatus casing, a first head unit, a second head unit, a first slider, a second slider, a first detection unit, a second detection unit, an input unit, and a control unit. The first head unit includes a first discharge head having a first ink discharge surface in which a first discharge port facing down, through which first ink is discharged, is formed, a first cap configured to cap the first ink discharge surface, and a first movement mechanism configured to switch the first ink discharge surface between a capped state in which the first ink discharge surface is isolated from an outside atmosphere with the first cap and a decapped state in which the capped state is canceled. The second head unit includes a second discharge head having a second discharge surface in which a second discharge port facing down, through which second ink is discharged, is formed, a second cap configured to cap the second ink discharge surface, and a second movement mechanism configured to switch the second ink discharge surface between a capped state in which the second ink discharge surface is isolated from the outside atmosphere with the second cap and a decapped state in which the capped state is canceled. The first slider supports the first head unit such that the first head unit is slidable between a first driving position in an inside space of the apparatus casing and a first maintenance position in an outside space of the apparatus casing. The second slider is provided separately from the first slider and supports the second head unit such that the second head unit is slidable between a second driving position in the inside space of the apparatus casing and a second maintenance position in the outside space of the apparatus casing. The first detection unit is configured to detect movement of the first head unit between the first driving position and the first maintenance position and output a first detection signal. The second detection unit is configured to detect movement of the second head unit between the second driving position and the second maintenance position and output a second detection signal. The input unit is configured to receive a first command including a command for switching the first ink discharge surface from the capped state to the decapped state and output a first input signal upon receipt of the first command, the input unit being configured to receive a second command including a command for switching the second ink discharge surface from the capped state to the decapped state and output a second input signal upon receipt of the second command. The control unit is electrically connected to the first discharge head, the first movement mechanism, the first detection unit, the second discharge head, the second movement mechanism, the second detection unit, and the input unit. The control unit is capable of individually performing a step a) of controlling the first movement mechanism so as to switch the first ink discharge surface from the capped state to the decapped state after elapse of a first predetermined time period when it is detected on the basis of the first detection signal received from the first detection unit, that the first head unit has moved from the first driving position to the first maintenance position while the first input signal has been received from the input unit, and a step b) of controlling the second movement mechanism so as to switch the second ink discharge surface from the capped state to the decapped state after elapse of a second predetermined time period when it is detected on the basis of the second detection signal received from the second detection unit, that the second head unit has moved from the second driving position to the second maintenance position while the second input signal has been received from the input unit.

The second invention of the present application is directed to the inkjet printing apparatus according to the first invention, wherein after the step a), the control unit controls the first movement mechanism so as to switch the first ink discharge surface from the decapped state to the capped state when it is detected on the basis of the first detection signal further received from the first detection unit, that the first head unit has moved from the first maintenance position to the first driving position. Meanwhile, after the step b), the control unit controls the second movement mechanism so as to switch the second ink discharge surface from the decapped state to the capped state when it is detected on the basis of the second detection signal further received from the second detection unit, that the second head unit has moved from the second maintenance position to the second driving position.

The third invention of the present application is directed to the inkjet printing apparatus according to the first invention or the second invention, the control unit recognizes presence of an error and waits while keeping the first ink discharge surface in the capped state when it is detected on the basis of the first detection signal received from the first detection unit, that the first head unit has moved from the first driving position to the first maintenance position while the first input signal is not received from the input unit. Meanwhile, the control unit recognizes presence of an error and waits while keeping the second ink discharge surface in the capped state when it is detected on the basis of the second detection signal received from the second detection unit, that the second head unit has moved from the second driving position to the second maintenance position while the second input signal is not received from the input unit.

The fourth invention of the present application is directed to the inkjet printing apparatus according to any of the first invention to the third invention, further including a first circulation path, a first circulation pump, a second circulation path, and a second circulation pump. The first circulation path includes a first supply tank in which the first ink supplied to the first discharge head is stored, a first collecting tank in which the first ink collected from the first discharge head is stored, and a first feedback pipe connecting the first collecting tank and the first supply tank. The first circulation pump is interposed in the first feedback pipe and is configured to deliver the first ink from the first collecting tank to the first supply tank via the first feedback pipe. The second circulation path includes a second supply tank in which the second ink supplied to the second discharge head is stored, a second collecting tank in which the second ink collected from the second discharge head is stored, and a second feedback pipe connecting the second collecting tank and the second supply tank. The second circulation pump is interposed in the second feedback pipe and is configured to deliver the second ink from the second collecting tank to the second supply tank via the second feedback pipe. The control unit is further electrically connected to the first circulation pump and the second circulation pump. Further, the control unit stops driving the first circulation pump when it is detected that the first head unit has moved from the first driving position to the first maintenance position. Meanwhile, the control unit stops driving the second circulation pump when it is detected that the second head unit has moved from the second driving position to the second maintenance position.

According to the first invention to the fourth invention of the present application, the ink discharge surface of the discharge head of the head unit to be subjected to maintenance is switched to a “decapped state” immediately before the maintenance of each head unit, and thus a time period for which the ink discharge surface of the head unit to be subjected to the maintenance is exposed to the outside atmosphere can be shortened. Consequently, each discharge port can be prevented from being dried. Further, commands for switching a plurality of head units to a “decapped state” can be input at once, which reduces a burden on the operator.

Especially, according to the second invention of the present application, immediately after maintenance is finished and the head unit is returned back to the inside space of the apparatus casing, the ink discharge surface of the returned head unit can be switched again to a “capped state”. Thus, a time period for which each ink discharge surface is exposed to the outside atmosphere can be further shortened. Therefore, each ink discharge surface can be further prevented from being dried.

Especially, according to the third invention of the present application, in a case in which a head unit not scheduled to be pulled out to the outside space is pulled out, the presence of an error can be recognized, and then the rest of work can be discontinued.

Especially, according to the fourth invention of the present application, circulation of ink is stopped, and thus ink leakage from the discharge port of the pulled-out head unit, intake of air through the discharge port, and the like can be prevented even though the head unit has been pulled out to the outside space. This suppresses a change in a pressure applied to the discharge head, to thereby suppress occurrence of damage or the like. Further, circulation of ink is stopped immediately before maintenance of each head unit, and thus the discharge port can be further prevented from being dried.

These and other objects, features, aspects, and advantages of the present invention will become more apparent from the following detailed description of the present invention when taken in conjunction with the accompanying drawings.

### BRIEF DESCRIPTION OF THE DRAWINGS

FIG. 1 is a view conceptually showing a configuration of an inkjet printing apparatus;

FIG. 2 is a perspective view diagrammatically showing a configuration of a head unit;

FIG. 3 is a view conceptually showing configurations of a discharge head and an ink supply unit of the head unit;

FIG. 4 is a bottom view of the discharge head and a head holding plate of the head unit as seen from below;

FIG. 5 is a view conceptually showing a positional relationship between the head unit and an apparatus casing of the inkjet printing apparatus;

FIG. 6 is a side view diagrammatically showing configurations of the head unit and a slider;

FIG. 7 is a side view diagrammatically showing configurations of the head unit and the slider;

FIG. 8 is a block diagram showing connection between a control unit and each component of the inkjet printing apparatus; and

FIG. 9 is a flowchart showing a procedure for performing maintenance of the head unit.

### DESCRIPTION OF THE PREFERRED EMBODIMENTS

Hereinafter, a preferred embodiment of the present invention will be described with reference to the drawings. Note that components described in this preferred embodiment are mere examples and are not intended to limit the scope of the present invention to those only. In the drawings, for the purpose of easier understanding, the dimensions or the number of respective components are overstated or understated in some portions of illustration, as necessary.

### 1. Configuration of Inkjet Printing Apparatus

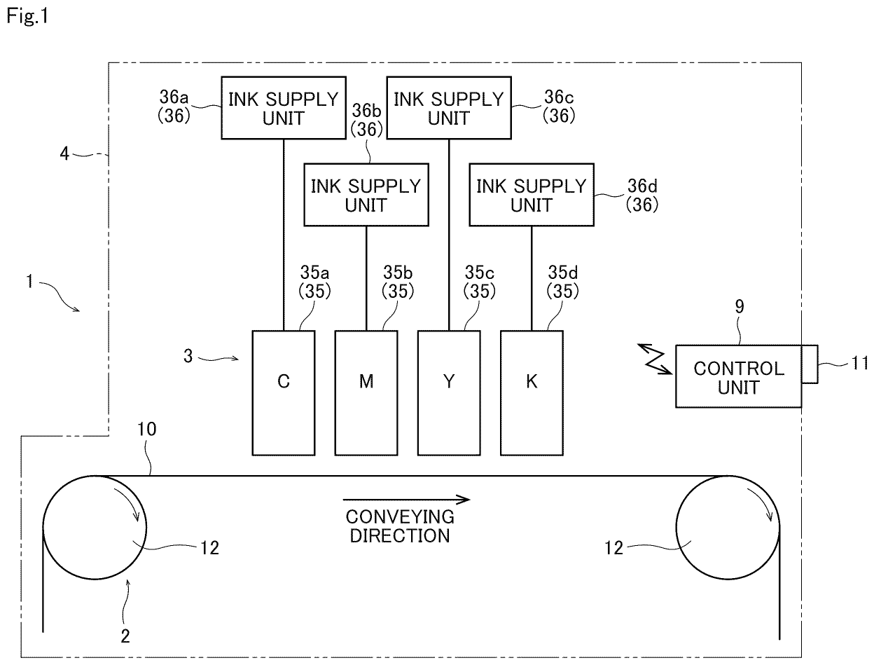

FIG. 1 is a view conceptually showing a configuration of an inkjet printing apparatus 1 according to one preferred embodiment of the present invention. The inkjet printing apparatus 1 is an inkjet printing machine that discharges droplets of water-based ink toward continuous paper 10 in a shape of a long strip from a plurality of head units 35 while conveying the continuous paper 10, to record characters or images on a surface of the continuous paper 10. Meanwhile, the continuous paper 10 in a shape of a long strip is just one example of a printing medium. The printing medium may be a cut sheet, a plastic film, a cardboard, metal foil, a material made of glass, or the like. In other words, the inkjet printing apparatus 1 may be any apparatus that can perform printing on a printing medium by an inkjet method.

The inkjet printing apparatus 1 includes a conveyor unit 2, a printing unit 3, an apparatus casing 4, a control unit 9, and an input unit 11. Further, as later described in detail, the printing unit 3 includes a plurality of head units 35. In the present preferred embodiment, the printing unit 3 includes four head units 35. The four head units 35 have substantially the same configuration with each other. Hence, in the following description and the drawings, when it is necessary to distinguish the four head units 35, suffix characters “a” to “d” are added to the reference numeral “35”, and the four head units 35 are referred to as a “first head unit 35a”, a “second head unit 35b”, a “third head unit 35c”, and a “fourth head unit 35d”. Meanwhile, when it is unnecessary to distinguish the four head units 35, the suffix characters are omitted.

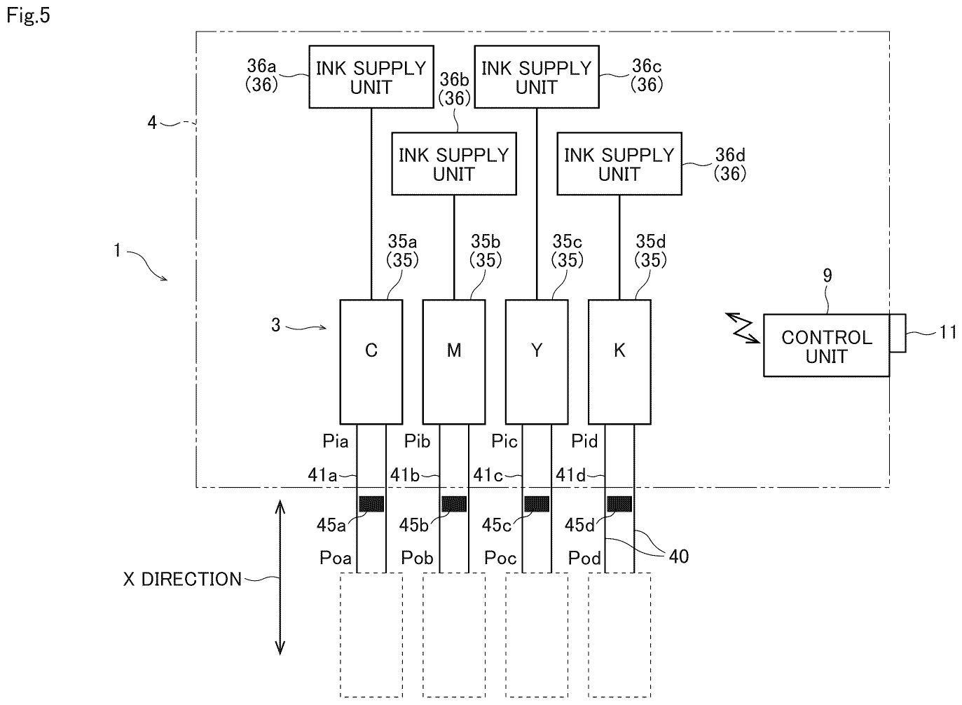

Further, in the inkjet printing apparatus 1, one ink supply unit 36, one slider 41 (refer to FIG. 5), and one detection unit (refer to FIG. 5) that correspond to each of the four head units 35 are provided. The ink supply units 36 corresponding to the four head units 35, respectively, have substantially the same configuration with each other. Hence, in the following description and the drawings, when it is necessary to distinguish the four ink supply units 36, suffix characters “a” to “d” are added to the reference numeral “36”, and the four ink supply units 36 are referred to as a “first ink supply unit 36a”, a “second ink supply unit 36b”, a “third ink supply unit 36c”, and a “fourth ink supply unit 36d”. Meanwhile, when it is unnecessary to distinguish the four ink supply units 36, the suffix characters are omitted. Moreover, the sliders 41 corresponding to the four head units 35, respectively, have substantially the same configuration with each other. Hence, in the following description and the drawings, when it is necessary to distinguish the four sliders 41, suffix characters “a” to “d” are added to the reference numeral “41”, and the four sliders 41 are referred to as a “first slider 41a”, a “second slider 41b”, a “third slider 41c”, and a “fourth slider 41d”. Meanwhile, when it is unnecessary to distinguish the four sliders 41, the suffix characters are omitted. Furthermore, the detection units 45 corresponding to the four head units 35, respectively, have substantially the same configuration with each other. Hence, in the following description and the drawings, when it is necessary to distinguish the four detection units 45, suffix characters “a” to “d” are added to the reference numeral “45”, and the four detection units 45 are referred to as a “first detection unit 45a”, a “second detection unit 45b”, a “third detection unit 45c”, and a “fourth detection 45d”. Meanwhile, when it is unnecessary to distinguish the four detection units 45, the suffix characters are omitted.

The conveyor unit 2 is a mechanism configured to convey the continuous paper 10 along a predetermined conveying path in a conveying direction extending along a length direction of the continuous paper 10. The continuous paper 10 is stretched over a plurality of conveyor rollers 12. The continuous paper 10 is conveyed along the conveying path formed by the plurality of conveyor rollers 12. Each of the conveyor rollers 12 rotates about an axis extending in a direction (width direction) perpendicular to the conveying direction, to thereby guide the continuous paper 10 to a downstream side in the conveying path. Further, the continuous paper 10 is under tension in the conveying direction. This reduces slack or wrinkles in the continuous paper 10 during conveying.

The printing unit 3 includes the plurality of head units 35 and the plurality of ink supply units 36. In the present preferred embodiment, the printing unit 3 includes four head units 35 and four ink supply units 36. As described above, the four head units 35 have substantially the same configuration with each other. Further, as described above, the four ink supply units 36 have substantially the same configuration with each other.

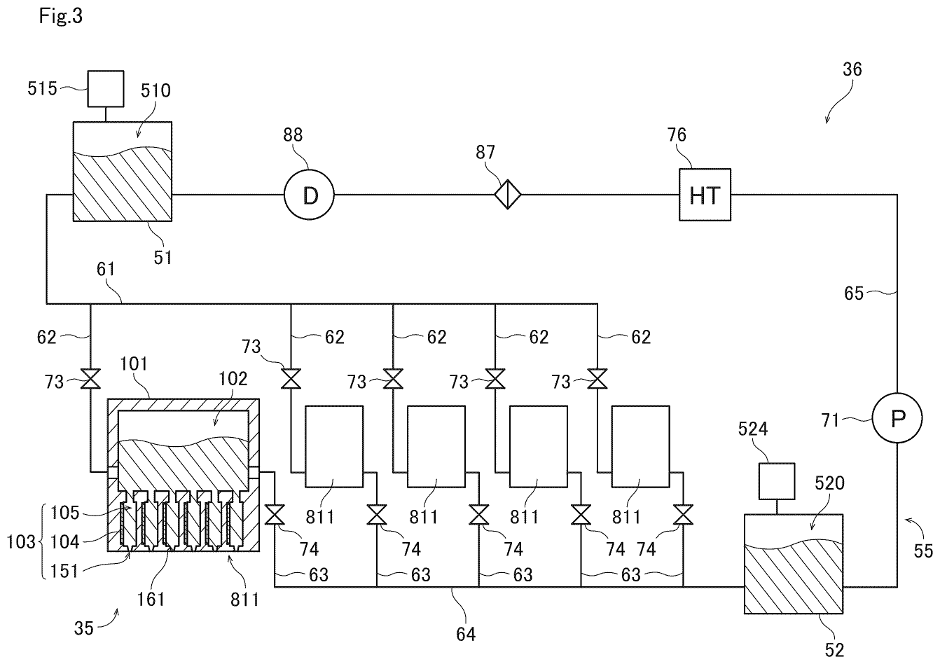

The four head units 35 are arranged while being spaced from each other along the conveying direction. Each of the four head units 35 discharges ink droplets toward a surface (upper surface) of the continuous paper 10 being conveyed in the conveying direction below the four head units 35, from nozzles 103 (refer to FIG. 3 described later). In the present preferred embodiment, the four head units 35 discharge ink of different colors, respectively, to thereby each record a monochromatic image on the surface (upper surface) of the continuous paper 10. For example, the four head units 35 discharge cyan ink, magenta ink, yellow ink, and black ink, respectively. Then, the four monochromatic images are superimposed, so that a multicolor image is formed on the upper surface of the continuous paper 10.

Meanwhile, in the following description and the drawings, when it is necessary to distinguish ink of different colors discharged from the four head units 35, cyan ink is referred to as a “first ink”, and the head unit 35 that discharges the first ink is be referred to as the “first head unit 35a”. Magenta ink is referred to as a “second ink”, and the head unit that discharges the second ink is referred to as the “second head unit 35b”. Yellow ink is referred to as a “third ink”, and the head unit 35 that discharges the third ink is referred to as the “third head unit 35c”. Black ink is referred to as the “fourth ink”, and the head unit 35 that discharges the fourth ink is referred to as the “fourth head unit 35d”. However, the colors of ink discharged from the respective head units 35a to 35d are not limited to those. The printing unit 3 may include a discharge head that discharges ink of a spot color such as orange, blue, or violet, in addition to cyan, magenta, yellow, and black.

Further, the ink supply unit 36 connected to the “first head unit 35a” is referred to as the “first ink supply unit 36a”. The ink supply unit 36 connected to the “second head unit 35b” is referred to as the “second ink supply unit 36b”. The ink supply unit 36 connected to the “third head unit 35c” is referred to as the “third ink supply unit 36c”. The ink supply unit 36 connected to the “fourth head unit 35d” is referred to as the “fourth ink supply unit 36d”. The configurations thereof will be later described in detail.

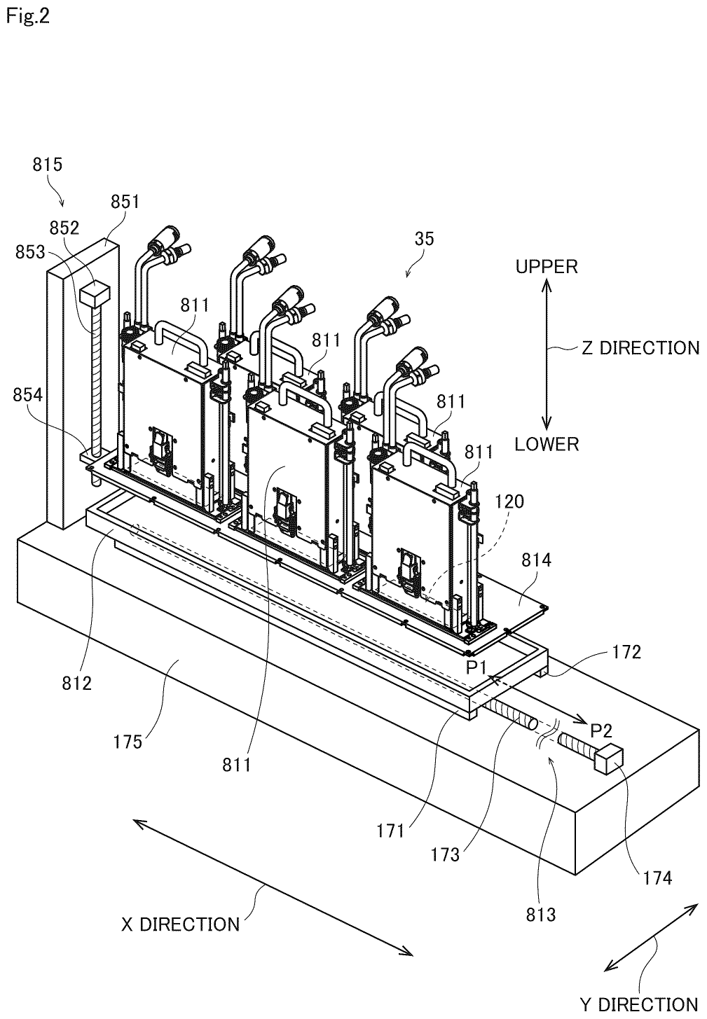

FIG. 2 is a perspective view diagrammatically showing a configuration of one head unit 35. Note that, in FIG. 2, a guided portion 176 mounted onto a support stand 175 described later is omitted. As shown in FIG. 2, each of the head units 35 includes a plurality of discharge heads 811, a cap 812, a main movement mechanism 813, a head holding plate 814, and a subsidiary movement mechanism 815. In the present preferred embodiment, each of the head units 35 includes five discharge heads 811.

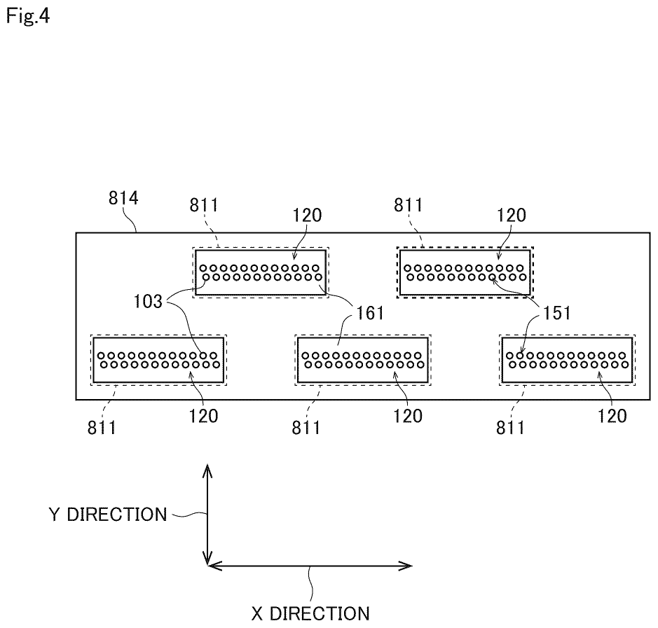

First, a configuration of the discharge head 811 is described. FIG. 3 is a view conceptually showing configurations of the plurality of discharge heads 811 and the ink supply unit 36 included in one head unit 35. Specifically, FIG. 3 is a view conceptually showing the configurations of the five discharge heads 811 and the ink supply unit 36 included in one head unit 35. FIG. 4 is a bottom view of the five discharge heads 811 and the head holding plate 814 as seen from below. Meanwhile, the five discharge heads 811 have substantially the same configuration with each other. Hence, in FIG. 3, only one of the five discharge heads 811 is shown in detail, and the other four discharge heads 811 are shown in a simplified manner.

As shown in FIG. 3, each of the five discharge heads 811 includes a casing 101, an internal tank 102, and a plurality of nozzles 103. The casing 101 forms an outer frame of the discharge head 811. The internal tank 102 is provided in the casing 101, and its corresponding ink can be temporarily stored therein. The plurality of nozzles 103 are arranged at regular intervals along the conveying direction and the width direction of the continuous paper on a lower side in the casing 101. Each of the plurality of nozzles 103 faces the upper surface of the continuous paper 10 being conveyed therebelow. Further, each of the plurality of nozzles 103 communicates with the internal tank 102. Moreover, each of the plurality of nozzles 103 includes a plurality of piezoelectric elements 104 serving as pressure generation elements, an ink chamber 105, and a discharge port 151. The ink chamber 105 communicates with the internal tank 102.

During discharge of ink, ink flows down from the internal tank 102 to the ink chamber 105. Then, under the control of the piezoelectric elements 104, ink in the ink chamber 105 is pressurized, and thus is discharged in the form of liquid droplets through the discharge port 151. That is, the discharge head 811 has an ink discharge surface 161 (lower surface) in which the discharge port 151 facing down, through which ink is discharged, is formed. Alternatively, the nozzle 103 may be a so-called thermal nozzle in which ink in the ink chamber 105 is heated to generate bubbles and thus is pressurized.

As shown in FIG. 2 and FIG. 4, the five discharge heads 811 are arranged in a zigzag (staggered) pattern in an upper surface of the head holding plate 814. The head holding plate 814 is a plate-shaped member extending in a rectangular shape and substantially horizontally. Hereinafter, a length direction of the head holding plate 814, a width direction of the head holding plate 814, and a direction perpendicular to the head holding plate 814 are referred to as an “X direction”, a “Y direction”, and a “Z direction”, respectively.

The head holding plate 814 includes five through holes 120. Each of the five through holes 120 passes through the head holding plate 814 along the Z direction. When the head holding plate 814 in which each discharge head 811 is placed on the upper surface is seen from below along the Z direction, the through holes 120 surround the plurality of nozzles 103 included in one discharge head 811 and are each slightly smaller than the ink discharge surface 161 of one discharge head 811. Thus, the plurality of discharge ports 151 of each of the discharge heads 811 are exposed on a lower-surface side of the head holding plate 814 via the through hole 120. As a result, ink can be discharged from each of the discharge heads 811 to the continuous paper 10 being conveyed therebelow via the through holes 120 of the head holding plate 814.

The cap 812 is a member having an area larger than that of the five discharge heads 811 or the head holding plate 814 as seen along the Z direction. The cap 812 is used for, for example, covering the nozzles 103 from below and isolating and enclosing the ink discharge surfaces 161 from an outside atmosphere, to prevent drying during stop of printing. That is, the cap 812 can cap the ink discharge surfaces 161 including the plurality of discharge ports 151. Note that a state in which the nozzles 103 of the five discharge heads 811 are isolated and enclosed from the outside atmosphere with the cap 812 as described above is referred to as a “capped state”. Meanwhile, as shown in FIG. 2, the cap 812 has a shape of substantially rectangular parallelepiped box and has a recess shape recessed downward. As a result of this, during purge, the cap 812 vertically faces the five discharge heads 811 and also can receive ink discharged (falling) from the five discharge heads 811. That is, the cap 812 can receive ink falling from the discharge port 151 when positioned at a facing position P1 (refer to FIG. 2) where the cap 812 faces the ink discharge surfaces 161 of the discharge heads 811 from below.

The main movement mechanism 813 includes a pair of linear guides 171 and 172, a ball screw 173, and a cap motor 174. The pair of linear guides 171 and 172, the ball screw 173, and the cap motor 174 are placed on a substantially horizontal upper surface of the support stand 175 having a substantially rectangular parallelepiped shape. Further, as shown in FIG. 2, the pair of linear guides 171 and 172 are each placed along the X direction.

The ball screw 173 extends along the X direction and is placed between the pair of linear guides 171 and 172. Further, the ball screw 173 is connected to the cap motor 174 and rotates when driven by the cap motor 174. The cap 812 is connected to the ball screw 173 via a connecting member not shown. The cap 812 moves as led by the pair of linear guides 171 and 172 along the X direction by rotation of the ball screw 173. Thus, the main movement mechanism 813 can move the cap 812 along the X direction between the facing position P1 where the cap 812 faces the ink discharge surfaces 161 of the five discharge heads 811 from below and a receding position P2 away from the facing position P1. As a result of this, the main movement mechanism 813 can move the cap 812, to cause the cap 812 to face the ink discharge surfaces 161 of the five discharge heads 811 from below, or to inhibit the cap 812 from facing the ink discharge surfaces 161 from below.

The subsidiary movement mechanism 815 is a mechanism that moves up and down (along the Z direction) the head holding plate 814 on which the discharge heads 811 are placed, by approximately a few centimeters to tens of centimeters. When the subsidiary movement mechanism 815 moves down the head holding plate 814 with the cap 812 positioned at the facing position P1, the head holding plate 814 comes into contact with the cap 812. This places the ink discharge surfaces 161 of the discharge heads 811 into an enclosed state (capped state). Further, when the subsidiary movement mechanism 815 moves up the head holding plate 814, the ink discharge surfaces 161 of the discharge heads 811 are released from a state in which the ink discharge surfaces 161 are enclosed with the cap 812.

Note that a state in which a “capped state” in which the nozzles 103 of the five discharge heads 811 are isolated and enclosed from the outside atmosphere with the cap 812 as described above is cancelled is referred to as a “decapped state”. That is, the subsidiary movement mechanism 815 can switch the ink discharge surfaces 161 between a “capped state” in which the ink discharge surfaces 161 are isolated from the outside atmosphere with the cap 812 and a “decapped state” in which the “capped state” is canceled. Below, a specific configuration of the subsidiary movement mechanism 815 is described. As shown in FIG. 2, the subsidiary movement mechanism 815 includes a support plate 851, a head motor 852, a ball screw 853, a pair of linear guides (not shown), and a screwing member 854.

The support plate 851 has a substantially rectangular parallelepiped shape. The support plate 851 is fixed to an upper surface of the support stand 175 and extends in a plate shape along a substantially vertical direction. The head motor 852 is fixed to the support plate 851. Further, the ball screw 853 is fixed to a rotation shaft of the head motor 852. The ball screw 853 extends along the Z direction. The ball screw 853 is placed between the pair of linear guides (not shown) extending along the Z direction. The screwing member 854 is fixed to the head holding plate 814 in which the five discharge heads 811 are placed. Further, the screwing member 854 includes a through hole. Around the through hole of the screwing member 854, an internal thread is formed. The ball screw 853 is inserted into the through hole of the screwing member 854. The ball screw 853 is screwed into the internal thread of the screwing member 854.

When the ball screw 853 is driven to rotate by the head motor 852, the screwing member 854 screwed into the ball screw 853 and the head holding plate 814 to which the screwing member 854 is fixed move as led by the pair of linear guides along the Z direction. Thus, the subsidiary movement mechanism 815 can simultaneously move up and down the five discharge heads 811 placed on the head holding plate 814. Consequently, the subsidiary movement mechanism 815 can bring the respective ink discharge surfaces 161 of the five discharge heads 811 close to the cap 812 to place them into a “capped state”, or can separate the ink discharge surfaces 161 from the cap 812 to place them into a “decapped state”.

Next, configurations of the first slider 41a to the fourth slider 41d are described. FIG. 5 is a view conceptually showing a positional relationship between the first head unit 35a to the fourth head unit 35d and the apparatus casing 4 in the inkjet printing apparatus 1. As shown in FIG. 5, in driving the inkjet printing apparatus 1, the first head unit 35a to the fourth head unit 35d are arranged side by side in an inside space of the apparatus casing 4. Further, the control unit 9 and the input unit 11 are provided near a wall portion of the apparatus casing 4 perpendicular to a row of a first maintenance position Poa to a fourth maintenance position Pod described later. The first head unit 35a to the fourth head unit 35d are each movable between the inside space and an outside space of the apparatus casing 4.

Specifically, as shown in FIG. 5, the first slider 41a that supports the first head unit 35a such that the first head unit 35a can slide between a first driving position Pia in the inside space of the apparatus casing 4 and the first maintenance position Poa in the outside space of the apparatus casing 4 is provided. Aside from the first slider 41a, the second slider 41b that supports the second head unit 35b such that the second head unit 35b can slide between a second driving position Pib in the inside space of the apparatus casing 4 and the second maintenance position Pob in the outside space of the apparatus casing 4 is provided. Aside from the first slider 41a and the second slider 41b, the third slider 41c that supports the third head unit 35c such that the third head unit 35c can slide between a third driving position Pic in the inside space of the apparatus casing 4 and the third maintenance position Poc in the outside space of the apparatus casing 4 is provided. Aside from the first slider 41a to the third slider 41c, the fourth slider 41d that supports the fourth head unit 35d such that the fourth head unit 35d can slide between a fourth driving position Pid in the inside space of the apparatus casing 4 and the fourth maintenance position Pod in the outside space of the apparatus casing 4 is provided.

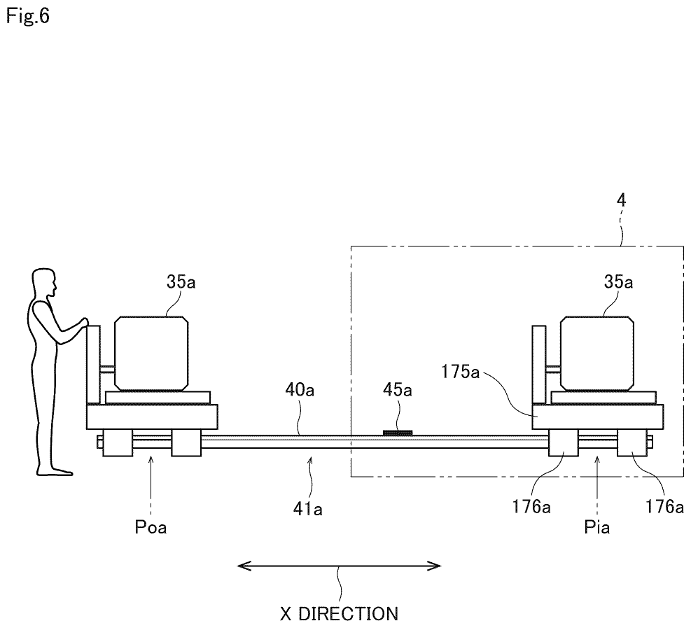

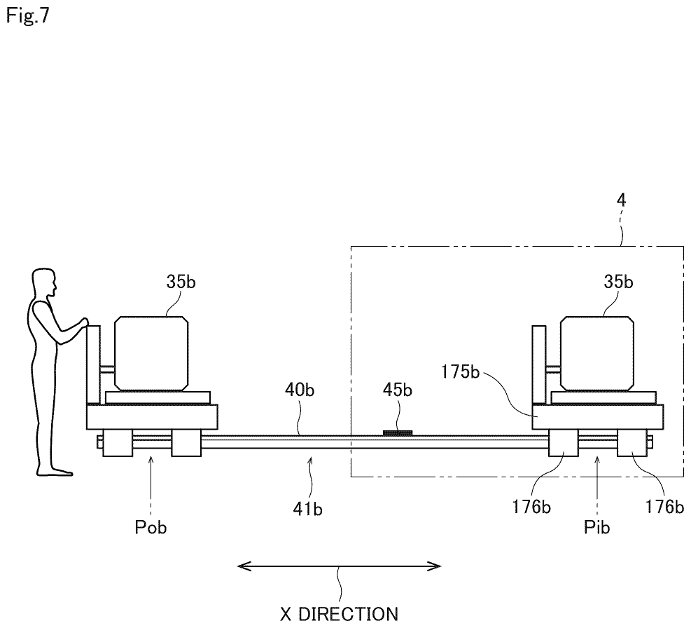

The first slider 41a, the second slider 41b, the third slider 41c, and the fourth slider 41d have substantially the same configuration with each other. Hence, the configurations of the first slider 41a and the second slider 41b are described below as an example. FIG. 6 is a side view diagrammatically showing the configurations of the first head unit 35a and the first slider 41a. FIG. 7 is a side view diagrammatically showing the configurations of the second head unit 35b and the second slider 41b.

As shown in FIG. 6, the first slider 41a is a guide rail extending from the first driving position Pia in the inside space of the apparatus casing 4 toward the first maintenance position Poa in the outside space of the apparatus casing 4. The first slider 41a includes a pair of first rail members 40a each extending along the X direction. When a first support stand 175a corresponding to the above-described support stand 175 is placed on the first slider 41a, a pair of first guided portions 176a provided in a lower surface of the first support stand 175a are engaged with the first rail members 40a so as to be slidable along the X direction. Thus, the first support stand 175a and the first head unit 35a held by the first support stand 175a are guided as led by the first slider 41a along the X direction. This allows the operator to pull out the first support stand 175a and the first head unit 35a held by the first support stand 175a from the first driving position Pia in the apparatus casing 4 to the first maintenance position Poa outside the apparatus casing 4, and push them back again to the first driving position Pia.

Further, in the first slider 41a, the first detection unit 45a including, for example, a photo-microsensor is fixed. Moreover, in the first support stand 175a, a sensor dog (not shown) for position detection is fixed. The first detection unit 45a outputs a detection signal each time the first detection unit 45a detects the sensor dog that passes in the vicinity as the first support stand 175a moves along the X direction. Hereinafter, the detection signal output from the first detection unit 45a is referred to as a “first detection signal”. That is, the first detection unit 45a detects movement of the first head unit 35a being supported by the first support stand 175a between the first driving position Pia and the first maintenance position Poa, and outputs the first detection signal. Thus, the control unit 9 described later can grasp a position of the first head unit 35a by referring to the first detection signal output from the first detection unit 45a.

As shown in FIG. 7, the second slider 41b is a guide rail extending from the second driving position Pib in the inside space of the apparatus casing 4 toward the second maintenance position Pob in the outside space of the apparatus casing 4. The second slider 41b includes a pair of second rail members 40b each extending along the X direction. When a second support stand 175b corresponding to the above-described support stand 175 is placed on the second slider 41b, a pair of second guided portions 176b provided in a lower surface of the second support stand 175b are engaged with the second rail members 40b so as to be slidable along the X direction. Thus, the second support stand 175b and the second head unit 35b held by the second support stand 175b are guided as led by the second slider 41b along the X direction. This allows the operator to pull out the second support stand 175b and the second head unit 35b held by the second support stand 175b from the second driving position Pib in the apparatus casing 4 to the second maintenance position Pob outside the apparatus casing 4, and push them back again to the second driving position Pib.

Further, in the second slider 41b, the second detection unit 45b including, for example, a photo-microsensor is fixed. Moreover, in the second support stand 175b, a sensor dog (not shown) for position detection is fixed. The second detection unit 45b outputs a detection signal each time the second detection unit 45b detects the sensor dog that passes in the vicinity as the second support stand 175b moves along the X direction. Hereinafter, the detection signal output from the second detection unit 45b is referred to as a “second detection signal”. That is, the second detection unit 45b detects movement of the second head unit 35b being supported by the second support stand 175b between the second driving position Pib and the second maintenance position Pob, and outputs the second detection signal. Thus, the control unit 9 described later can grasp a position of the second head unit 35b by referring to the second detection signal output from the second detection unit 45b.

Likewise, in the third slider 41c, the third detection unit 45c is fixed. The third detection unit 45c detects movement of the third head unit 35c being supported by the support stand 175 between the third driving position Pic and the third maintenance position Poc, and outputs a third detection signal. Likewise, in the fourth slider 41d, the fourth detection unit 45d is fixed. The fourth detection unit 45d detects movement of the fourth head unit 35d being supported by the support stand 175 between the fourth driving position Pid and the fourth maintenance position Pod, and outputs a fourth detection signal.

Next, a configuration of the ink supply unit 36 is described in detail. The ink supply unit 36 is a device configured to supply ink to the head unit 35 while circulating a part of ink. As shown in FIG. 3, the ink supply unit 36 includes a supply tank 51, a collecting tank 52, a supply-side manifold 61, and a plurality of supply-side narrow pipes 62, a plurality of collecting-side narrow pipes 63, a collecting-side manifold 64, a feedback pipe 65, a circulation pump 71, a plurality of supply-side on-off valves 73, a plurality of head outlet-side on-off valves 74, a heater 76, a filter 87, and a deaeration unit 88. In the present preferred embodiment, the ink supply unit 36 includes five supply-side narrow pipes 62, five collecting-side narrow pipes 63, five supply-side on-off valves 73, and five head outlet-side on-off valves 74.

The supply tank 51 is a container for temporally storing ink to be supplied to the discharge head 811. In the supply tank 51, an internal chamber 510 in which ink can be temporally stored is provided.

The supply-side manifold 61 and the five supply-side narrow pipes 62 are pipes connecting the supply tank 51 and the five discharge heads 811 included in one head unit 35. The supply-side manifold 61 is a wide pipe having an upstream end that is connected so as to communicate with the internal chamber 510 of the supply tank 51. Each of the five supply-side narrow pipes 62 is a narrow pipe branching from the supply-side manifold 61. Each of the five supply-side narrow pipes 62 has an upstream end communicating with an internal passage of the supply-side manifold 61, and has a downstream end that is connected so as to communicate with the internal tank 102 of one discharge head 811.

Further, in the present preferred embodiment, the supply-side on-off valve 73 is interposed in each of the supply-side narrow pipes 62. For the supply-side on-off valve 73, for example, a solenoid valve that is opened and closed under the control of the control unit 9 is used. Alternatively, for the supply-side on-off valve 73, an on-off valve that is manually opened and closed may be used. While the supply-side on-off valve 73 is closed, communication of an internal passage of the supply-side narrow pipe 62 is blocked. That is, while the supply-side on-off valve 73 is closed, flow of ink from the supply tank 51 to the discharge head 811 is interrupted. Meanwhile, while the supply-side on-off valve 73 is opened, communication of the internal passage of the supply-side narrow pipe 62 is allowed. Note that the supply-side on-off valve 73 is not necessarily required to be provided.

The five collecting-side narrow pipes 63 and the collecting-side manifold 64 are pipes connecting the five discharge heads 811 included in the head unit 35 and the collecting tank 52. Each of the five collecting-side narrow pipes 63 is a narrow pipe branching from the collecting-side manifold 64. Each of the five collecting-side narrow pipes 63 has an upstream end that is connected so as to communicate with the internal tank 102 of one discharge head 811, and has a downstream end that is connected so as to communicate with an internal passage of the collecting-side manifold 64. The collecting-side manifold 64 is a wide pipe having a downstream end that is connected so as to communicate with an internal chamber 520 of the collecting tank 52 described later.

Further, in the present preferred embodiment, the head outlet-side on-off valve 74 is interposed in each of the collecting-side narrow pipes 63. For the head outlet-side on-off valve 74, for example, a solenoid valve that is opened and closed under the control of the control unit 9 is used. Alternatively, for the head outlet-side on-off valve 74, an on-off valve that is manually opened and closed may be used. While the head outlet-side on-off valve 74 is closed, communication of an internal passage of the collecting-side narrow pipe 63 is blocked. That is, while the head outlet-side on-off valve 74 is closed, flow of ink from the discharge head 811 to the collecting tank 52 is interrupted. Meanwhile, while the head outlet-side on-off valve 74 is opened, communication of the internal passage of the collecting-side narrow pipe 63 is allowed. Note that the head outlet-side on-off valve 74 is not necessarily required to be provided.

The collecting tank 52 is a container for temporally storing ink collected from the discharge heads 811. In the collecting tank 52, the internal chamber 520 in which ink can be temporally stored is provided.

Further, as shown in FIG. 3, the supply tank 51 is connected to a pressurization mechanism 515. The pressurization mechanism 515 pressurizes the inside of the supply tank 51, to regulate a pressure of the internal chamber 510 of the supply tank 51 to a positive pressure. Specifically, the pressurization mechanism 515 regulates a pressure of the internal chamber 510 of the supply tank 51 to a pressure higher than the atmospheric pressure. The pressurization mechanism 515 includes, for example, a compressor, a pressurization buffer tank, a pressure regulation mechanism (regulator), and the like.

Meanwhile, the collecting tank 52 is connected to a decompression mechanism 524. The decompression mechanism 524 decompresses the inside of the collecting tank 52, to regulate a pressure of the internal chamber 520 of the collecting tank 52 to a negative pressure. Specifically, the decompression mechanism 524 regulates a pressure of the internal chamber 520 of the collecting tank 52 to a pressure lower than the atmospheric pressure. The decompression mechanism 524 includes, for example, a vacuum pump, a decompression buffer tank, a pressure regulation mechanism (regulator), and the like.

Note that the pressurization mechanism 515 and the decompression mechanism 524 are configured such that the operations thereof can be controlled by the control unit 9. When the pressurization mechanism 515 and the decompression mechanism 524 are driven, there is generated a pressure difference between the internal chamber 510 of the supply tank 51 and the internal chamber 520 of the collecting tank 52. Thus, ink stored in the supply tank 51 can be supplied to each discharge head 811, and further, ink remaining in each discharge head 811 can be collected into the collecting tank 52. Note that the ink remaining in the discharge head 811 is ink being left undischarged in each discharge head 811.

The feedback pipe 65 is a pipe connecting the internal chamber 520 of the collecting tank 52 and the internal chamber 510 of the supply tank 51 such that the internal chambers can communicate with each other. In other words, the feedback pipe 65 connects the collecting tank 52 and the supply tank 51. As shown in FIG. 3, an internal passage of the feedback pipe 65 has an upstream end that is connected so as to communicate with the internal chamber 520 of the collecting tank 52. Further, the internal passage of the feedback pipe 65 has a downstream end that is connected so as to communicate with the internal chamber 510 of the supply tank 51.

With the above-described configuration, there is formed an ink circulation path 55 that extends from the supply tank 51, passes through the supply-side manifold 61, the supply-side narrow pipes 62, the internal tanks 102 of the discharge heads 811, the collecting-side narrow pipes 63, the collecting-side manifold 64, the collecting tank 52, and the feedback pipe 65, and returns back to the supply tank 51. In other words, the circulation path 55 includes the supply tank 51, the discharge heads 811, the collecting tank 52, and the feedback pipe 65. Further, in the feedback pipe 65, the circulation pump 71, the heater 76, the filter 87, and the deaeration unit 88 are interposed.

The circulation pump 71 is a device configured to perform a liquid-delivery operation of delivering ink from the collecting tank 52 to the supply tank 51 via the feedback pipe 65. The circulation pump 71 is electrically connected to the control unit 9. The circulation pump 71 generates flow of ink from the collecting tank 52 to the supply tank 51 in the internal passage of the feedback pipe 65 in response to an operation signal from the control unit 9.

The heater 76 is a device configured to heat ink delivered through the internal passage of the feedback pipe 65. The heater 76 heats ink flowing from the collecting tank 52 to the supply tank 51. The heater 76 is positioned between the circulation pump 71 and the supply tank 51 in the feedback pipe 65. The heater 76 is electrically connected to the control unit 9.

The filter 87 is interposed on the downstream side of the heater 76 with respect to an ink delivery direction and on the upstream side of the supply tank 51 with respect to the ink delivery direction, in the feedback pipe 65. The filter 87 filters ink delivered through the internal passage of the feedback pipe 65, to remove foreign matters included in the ink.

The deaeration unit 88 is interposed on the downstream side of the filter 87 with respect to the ink delivery direction and on the upstream side of the supply tank 51 with respect to the ink delivery direction, in the feedback pipe 65. The deaeration unit 88 of the present preferred embodiment is a so-called hollow-fiber membrane deaeration module. The deaeration unit 88 removes bubbles in ink delivered through the internal passage of the feedback pipe 65.

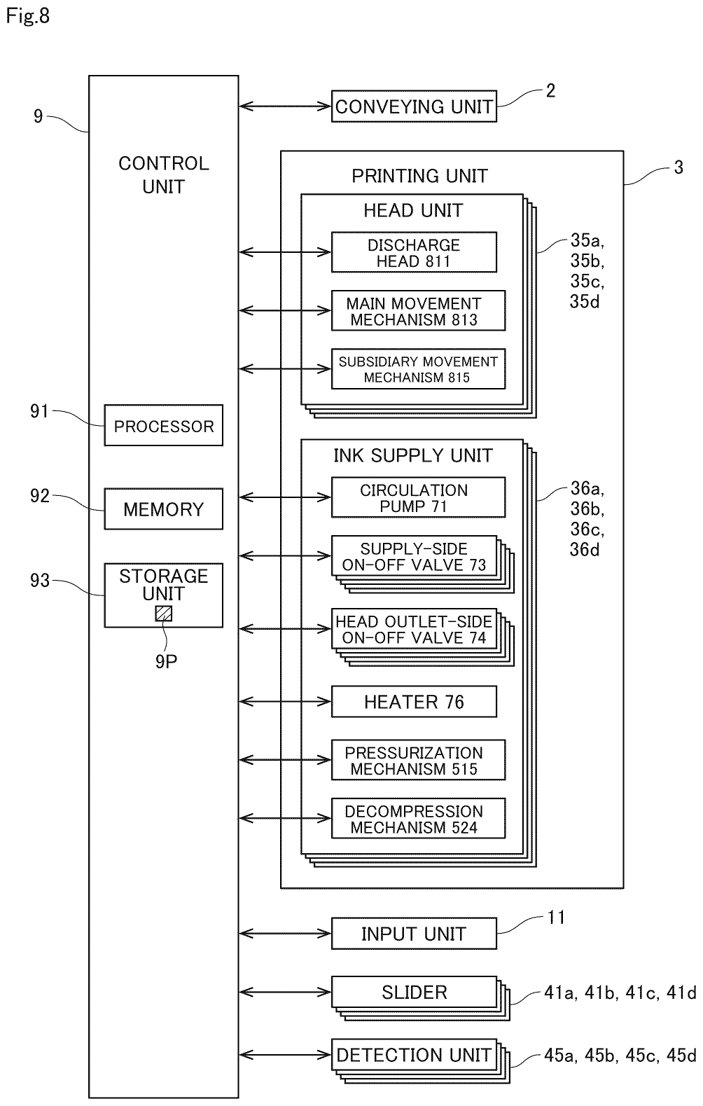

Next, the control unit 9 is described. The control unit 9 is an information processing device configured to control each component of the inkjet printing apparatus 1. FIG. 8 is a block diagram showing connection between the control unit 9 and each component of the inkjet printing apparatus 1. As conceptually shown in FIG. 8, the control unit 9 includes a processor 91 such as a CPU, a memory 92 such as a RAM, and a storage unit 93 such as a hard disk drive. In the storage unit 93, a computer program 9P for conveying the continuous paper, 10, performing printing, circulating ink, performing maintenance of the first head unit 35a to the fourth head unit 35d, is stored.

Further, as shown in FIG. 8, the control unit 9 is electrically connected to the conveyor unit 2, to the discharge heads 811, the main movement mechanism 813, and the subsidiary movement mechanism 815 of each of the four head units 35a to 35d of the printing unit 3, to the circulation pump 71, the five supply-side on-off valves 73, the five head outlet-side on-off valves 74, the heater 76, the pressurization mechanism 515, and the decompression mechanism 524 of each of the four ink supply units 36a to 36d of the printing unit 3, to the four sliders 41a to 41d, and to the four detection units 45a to 45d such that the control unit 9 can conduct communication to/from each component. The control unit 9 controls operations of those components in accordance with the computer program 9P.

Further, as shown in FIG. 8, the control unit 9 is electrically connected to the input unit 11 such that the control unit 9 can conduct communication to/from the input unit 11. The input unit 11 is a device that can receive a command for making a transition of the plurality of head units 35 to a maintenance mode. More specifically, the input unit 11 is a device that can receive a first command for moving the cap 812 of the first head unit 35a from the facing position P1 to the receding position P2, and/or receive a second command for moving the cap 812 of the second head unit 35b from the facing position P1 to the receding position P2, and/or receive a third command for moving the cap 812 of the third head unit 35c from the facing position P1 to the receding position P2, and/or receive a fourth command for moving the cap 812 of the fourth head unit 35d from the facing position P1 to the receding position P2.

Note that the first command includes a command for driving the subsidiary movement mechanism 815 of the first head unit 35a and switching the ink discharge surface 161 of each of the five discharge heads 811 from a “capped state” to a “decapped state”. The second command includes a command for driving the subsidiary movement mechanism 815 of the second head unit 35b and switching the ink discharge surface 161 of each of the five discharge heads 811 from a “capped state” to a “decapped state”. The third command includes a command for driving the subsidiary movement mechanism 815 of the third head unit 35c and switching the ink discharge surface 161 of each of the five discharge heads 811 from a “capped state” to a “decapped state”. The fourth command includes a command for driving the subsidiary movement mechanism 815 of the fourth head unit 35d and switching the ink discharge surface 161 of each of the five discharge heads 811 from a “capped state” to a “decapped state”.

The input unit 11 includes, for example, an input interface such as a touch panel. The operator individually inputs, to the input unit 11, the above-described first to fourth commands for making a transition of the first head unit 35a to fourth head unit 35d to a maintenance mode via the input interface. Then, upon receipt of the first command, the input unit 11 outputs a first input signal which is a signal related to the first command, to the control unit 9. Upon receipt of the second command, the input unit 11 outputs a second input signal which is a signal related to the second command, to the control unit 9. Upon receipt of the third command, the input unit 11 outputs a third input signal which is a signal related to the third command, to the control unit 9. Upon receipt of the fourth command, the input unit 11 outputs a fourth input signal which is a signal related to the fourth command, to the control unit 9. Meanwhile, the input unit 11 may be formed integrally with the control unit 9 or another unit.

### 2. Procedure for Conveying Continuous Paper, Printing, Circulating Ink, and Performing Maintenance of Head Unit

Next, a procedure for conveying the continuous paper 10, performing printing on the continuous paper 10, circulating ink, and performing maintenance of the first head unit 35a to the fourth head unit 35d performed in the inkjet printing apparatus 1 is described.

In conveying the continuous paper 10, performing printing on the continuous paper 10, and circulating ink, first, the control unit 9 causes the conveyor unit 2 to operate, to thereby convey the continuous paper 10 along a predetermined conveying path in the length direction. Then, the control unit 9 controls the plurality of nozzles 103 of each of the four head units 35 (the first head unit 35a to the fourth head unit 35d) while conveying the continuous paper 10, to discharge droplets of the first ink to the fourth ink onto the surface of the continuous paper 10. As a result of this, a multicolor image is recorded on the surface of the continuous paper 10.

Meanwhile, as advance preparation for conveying the continuous paper 10, performing printing on the continuous paper 10, and circulating ink, a sufficient amount of ink is stored in the internal chamber 510 of the supply tank 51 of each of the four ink supply units 36 (the first ink supply unit 36a to the fourth ink supply unit 36d). Further, the control unit 9 opens the five supply-side on-off valves 73 and the five head outlet-side on-off valves 74 of each ink supply unit 36. Then, the control unit 9 drives the circulation pump 71, the heater 76, the pressurization mechanism 515, and the decompression mechanism 524 of each of the four ink supply units 36 (the first ink supply unit 36a to the fourth ink supply unit 36d). Specifically, the control unit 9 drives the circulation pump 71 to circulate ink through the ink circulation path 55 while driving the pressurization mechanism 515 and the decompression mechanism 524, to thereby supply the first ink to the fourth ink to the internal tanks 102 of the corresponding discharge heads 811, respectively.

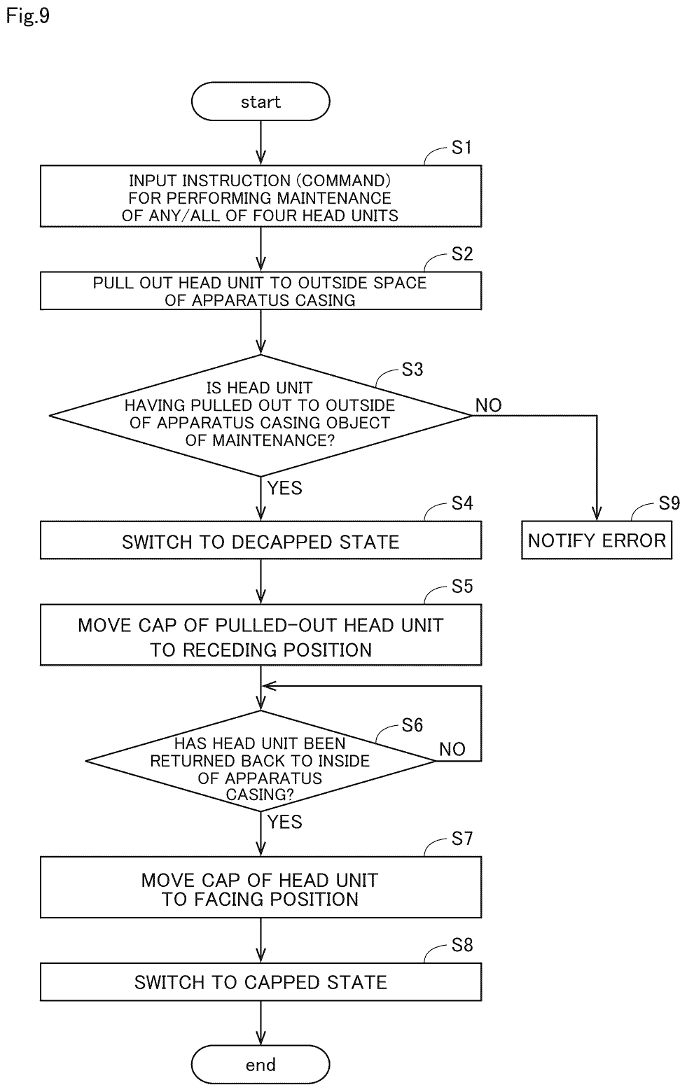

Next, a procedure for performing maintenance of the first head unit 35a to the fourth head unit 35d is described. FIG. 9 is a flowchart showing the procedure for performing maintenance of the first head unit 35a to the fourth head unit 35d. It is supposed that the inkjet printing apparatus 1 is in a standby state at a time of starting maintenance shown in FIG. 9. Specifically, conveyance of the continuous paper 10 is stopped, and the first head unit 35a to the fourth head unit 35d stop discharging ink droplets onto the continuous paper 10. Further, the cap 812 of each of the first head unit 35a to the fourth head unit 35d is positioned at the facing position P1. Moreover, the five discharge heads 811 of each of the first head unit 35a to the fourth head unit 35d are moved down by driving of the subsidiary movement mechanism 815. As a result of this, the ink discharge surface 161 of each of the discharge heads 811 is isolated and enclosed from the outside atmosphere with the cap 812, and thus is in a “capped state”

While the inkjet printing apparatus is in the standby state described above, maintenance of the first head unit 35a to the fourth head unit 35d is started. The operator inputs a command for making a transition of any or all of the first head unit 35a to the fourth head unit 35d to a maintenance mode via the input interface of the input unit 11 (step S1). In other words, the operator inputs the first command, the second command, the third command, and/or the fourth command described above via the input interface of the input unit 11. In the following description, there is supposed a case in which the operator inputs a command (the first command and the second command) for performing maintenance of the first head unit 35a and the second head unit 35b, as an example.

In this case, the input unit 11 outputs the first input signal to the control unit 9 upon receipt of the first command. Further, the input unit 11 outputs the second input signal to the control unit 9 upon receipt of the second command. Thus, the control unit 9 receives the first input signal and the second input signal from the input unit 11. However, at this stage, the control unit 9 does not perform control for driving the main movement mechanism 813 and the subsidiary movement mechanism 815 of each of the first head unit 35a and the second head unit 35b.

Subsequently, the operator pulls out any of the first head unit 35a to the fourth head unit 35d to the outside space of the apparatus casing 4 to perform maintenance (step S2). For example, the operator first pulls out the first support stand 175a and the first head unit 35a placed on the first slider 41a from the first driving position Pia in the apparatus casing 4 to the first maintenance position Poa outside the apparatus casing 4. Then, the first detection unit 45a detects that the first head unit 35a has moved between the first driving position Pia and the first maintenance position Poa, and outputs the first detection signal. Thus, the control unit 9 can grasp that the first head unit 35a has moved from the first driving position Pia to the first maintenance position Poa by referring to the first detection signal output from the first detection unit 45a.

Meanwhile, the control unit 9 stops driving the circulation pump 71 of the first ink supply unit 36a when it is detected that the first head unit 35a has moved from the first driving position Pia to the first maintenance position Poa. By stopping circulation of the first ink, it is possible to prevent ink leakage from the discharge ports 151 of the discharge heads 811 of the first head unit 35a, intake of air from the outside atmosphere through the discharge ports 151, and the like even though the first head unit 35a has been pulled out to the outside of the apparatus casing 4. This can suppress a change in a pressure applied to the discharge heads 811, to thereby prevent damage or the like to the discharge heads 811. Further, the control unit 9 closes the supply-side on-off valves 73 and the head outlet-side on-off valves 74 of the first ink supply unit 36a. This can further prevent ink leakage from the discharge ports 151 of the discharge heads 811 of the first head unit 35a, intake of air from the outside atmosphere through the discharge ports 151, and the like.

Subsequently, the control unit 9 checks whether the head unit 35 having been pulled out to the outside space of the apparatus casing 4 has been input to the input unit 11, as an object of maintenance in the step S1, in the first place (step S3). In the present preferred embodiment, it is checked whether the first head unit 35a having moved to the first maintenance position Poa outside the apparatus casing 4 has been input to the input unit 11, as an object of maintenance. The first head unit 35a has been input to the input unit 11, as an object of maintenance in the step S1 as described above (step S3: YES), and thus the control unit 9 drives the main movement mechanism 813 and the subsidiary movement mechanism 815 of the first head unit 35a after a certain time lag. More specifically, the control unit 9 drives the subsidiary movement mechanism 815 of the first head unit 35a, and switches the ink discharge surface 161 of each discharge head 811 of the first head unit 35a to a “decapped state” (step S4). This allows the operator to check the condition of the ink discharge surface 161 of each discharge head 811 and perform a part of maintenance. After that, the control unit 9 drives the main movement mechanism 813, to move the cap 812 of the first head unit 35a from the facing position P1 to the receding position P2, and entirely exposes the ink discharge surface 161 of each discharge head 811 (step S5). This allows the operator to make full access to the ink discharge surface 161 and thus easily perform cleaning of portions near the nozzles 103, part replacement, and the like.

Then, when finishing maintenance including cleaning of each discharge head 811, part replacement, and the like, the operator pushes back the first support stand 175a and the first head unit 35a placed on the first slider 41a from the first maintenance position Poa outside the apparatus casing 4 to the first driving position Pia in the apparatus casing 4. As a result, the first detection unit 45a detects that the first head unit 35a has moved between the first maintenance position Poa and the first driving position Pia, and outputs the first detection signal. Thus, the control unit 9 can grasp that the first head unit 35a has moved from the first maintenance position Poa to the first driving position Pia by referring to the first detection signal output from the first detection unit 45a. Meanwhile, when it is detected that the first head unit 35a has moved from the first maintenance position Poa to the first driving position Pia (step S6: YES), the control unit 9 drives the main movement mechanism 813 of the first head unit 35a again. Thus, the control unit 9 moves the cap 812 from the receding position P2 to the facing position P1, so that the cap 812 faces each discharge head 811 (step S7). Further, the control unit 9 drives the subsidiary movement mechanism 815 of the first head unit 35a again. As a result, the head holding plate 814 and the five discharge heads 811 of the first head unit 35a are moved down. Consequently, the ink discharge surface 161 of each discharge head 811 can be switched again to a “capped state” in which the ink discharge surface 161 is isolated and enclosed from the outside atmosphere with the cap 812 (step S8).

As described above, the control unit 9 can perform operations of pulling out the apparatus casing 4 to the outside space, performing maintenance including cleaning, part replacement, and the like, and pushing back the apparatus casing 4 to the inside space, on each of the first head unit 35a to the fourth head unit 35d. Then, the cap 812 in each of the head units 35a to 35d can be moved to the receding position P2, and respective commands for switching the head units 35a to 35d to a “decapped state” can be input at once in the input unit 11. This can reduce a burden on the operator. Further, the ink discharge surfaces 161 of the five discharge heads 811 of the head units 35a to 35d to be subjected to maintenance are switched to a “decapped state” immediately before maintenance of the head units 35a to 35d is actually performed. Thus, a time period for which the ink discharge surfaces 161 of the head units 35a to 35d to be subjected to maintenance are exposed to the outside atmosphere can be further shortened. Consequently, the nozzles 103 formed in the ink discharge surfaces 161 can be prevented from being dried. Meanwhile, the ink discharge surface 161 of the head unit 35 not to be subjected to maintenance is kept in a “capped state” also during maintenance of another head unit 35. In the case described in the present preferred embodiment, the ink discharge surfaces 161 of the third head unit 35c and the fourth head unit 35d are kept in a “capped state” also during maintenance of the first head unit 35a and the second head unit 35b. Therefore, the nozzles 103 formed in the ink discharge surfaces 161 of the head units 35 not to be subjected to maintenance can be prevented from being dried.

In other words, the control unit 9 of the present preferred embodiment can perform each of a step a) of controlling the subsidiary movement mechanism 815 (first movement mechanism) of the first head unit 35a, to switch the ink discharge surfaces 161 of the first head unit 35a from a “capped state” to a “decapped state” after elapse of a first predetermined time period when it is detected on the basis of the first detection signal received from the first detection unit 45a, that the first head unit 35a has moved from the first driving position Pia to the first maintenance position Poa while the first input signal has been received from the input unit 11; and a step b) of controlling the subsidiary movement mechanism 815 (second movement mechanism) of the second head unit 35b, to switch the ink discharge surfaces 161 of the second head unit 35b from a “capped state” to a “decapped state” after elapse of a second predetermined time period when it is detected on the basis of the second detection signal received from the second detection unit 45b, that the second head unit 35b has moved from the second driving position Pib to the second maintenance position Pob while the second input signal has been received from the input unit 11.

Further, as described above, when it is detected that any of the head units 35 has moved from the driving position in the apparatus casing 4 to the maintenance position outside the apparatus casing 4, the control unit 9 stops driving the circulation pump 71 of the ink supply unit 36 corresponding to the head unit 35 having moved. This results in stopping circulation of ink in the ink supply unit 36 corresponding to the head unit 35 having moved to the maintenance position. Consequently, even though the head unit 35 has been pulled out to the outside of the apparatus casing 4, ink leakage from the discharge ports 151 of the discharge heads 811 of the pulled-out head unit 35, intake of air from the outside atmosphere through the discharge ports 151, and the like can be prevented. This can suppress a change in a pressure applied to the discharge heads 811, to thereby prevent damage or the like to the discharge heads 811. Further, in the ink supply unit 36 corresponding to the head unit 35 not to be subjected to maintenance, ink circulation is continued also during maintenance of another head unit 35. In the case described in the present preferred embodiment, in the ink supply units 36 corresponding to the third head unit 35c and the fourth head unit 35d, ink circulation is continued also during maintenance of the first head unit 35a and the second head unit 35b. Therefore, the discharge ports 151 of the discharge heads 811 of the head units 35 not to be subjected to maintenance can be further prevented from being dried.

Specifically, when it is detected that the first head unit 35a has moved from the first driving position Pia to the first maintenance position Poa, the control unit 9 of the present preferred embodiment stops driving the circulation pump 71 (first circulation pump) of the first ink supply unit 36a. Meanwhile, when it is detected that the second head unit 35b has moved from the second driving position Pib to the second maintenance position Pob, the control unit 9 of the present preferred embodiment stops driving the circulation pump 71 (second circulation pump) of the second ink supply unit 36b. In this manner, in the present preferred embodiment, ink circulation is stopped immediately before maintenance of the head units 35a and 35b, and thus the discharge ports 151 can be further prevented from being dried.

Further, as described above, when finishing maintenance including cleaning, part replacement, and the like of any of the head units 35a to 35d, the operator pushes back the head unit 35a, 35b, 35c, or 35d from the maintenance position Poa, Pob, Poc, or Pod outside the apparatus casing 4 to the driving position Pia, Pib, Pic, or Pid in the apparatus casing 4. Then, when it is detected on the basis of the first, second, third, or fourth detection signal, that any of the head units 35a to 35d has moved from the maintenance position Poa, Pob, Poc, or Pod to the driving position Pia, Pib, Pic, or Pid, the control unit 9 drives again the main movement mechanism 813 and the subsidiary movement mechanism 815 of the corresponding head unit 35a, 35b, 35c, or 35d. Thus, the control unit 9 moves the cap 812 of the corresponding head unit 35a, 35b, 35c, or 35d from the receding position P2 to the facing position P1. Further, the control unit 9 brings the ink discharge surfaces 161 of the discharge heads 811 of the corresponding head unit 35a, 35b, 35c, or 35d into contact with the corresponding cap 812 again. As a result, the ink discharge surfaces 161 are switched again to a “capped state” by the cap 812 immediately after an end of maintenance of the corresponding head unit 35a, 35b, 35c, or 35d. Hence, a time period for which the ink discharge surfaces 161 of the corresponding head unit 35a, 35b, 35c, or 35d having been subjected to maintenance are exposed to the outside atmosphere can be further shortened. Consequently, the ink discharge surfaces 161, together with the nozzles 103 formed in the ink discharge surfaces 161, can be further prevented from being dried.

In other words, after the above-described step a), when it is detected on the basis of the first detection signal further received form the first detection unit 45a, that the first head unit 35a has moved from the first maintenance position Poa to the first driving position Pia, the control unit 9 controls the subsidiary movement mechanism 815 (first movement mechanism) of the first head unit 35a, to cap the ink discharge surface 161 (first ink discharge surface) of each discharge head 811 of the first head unit 35a with the corresponding cap 812 (first cap). Meanwhile, after the above-described step b), when it is detected on the basis of the second detection signal further received form the second detection unit 45b, that the second head unit 35b has moved from the second maintenance position Pob to the second driving position Pib, the control unit 9 controls the subsidiary movement mechanism 815 (second movement mechanism) of the second head unit 35b, to cap the ink discharge surface 161 (second ink discharge surface) of each discharge head 811 of the second head unit 35b with the corresponding cap 812 (second cap).

Moreover, as described above, in the step S3, the control unit 9 checks whether the head unit 35 having been pulled out to the outside space of the apparatus casing 4 has been input to the input unit 11, as an object of maintenance in the step S1, in the first place. Then, the control unit 9 opens or closes the cap 812 only when an answer to the step S3 is YES. With this configuration, the operator can proceed with maintenance work while checking whether the maintenance work are performed as originally planned. This results in performing the work more correctly.

Here, suppose a case in which maintenance of the first head unit 35a is not scheduled and the operator does not input the first command to the input unit 11 in the step S1. Then, when it is checked that the first head unit 35a having been pulled out to the outside of the apparatus casing 4, has not been input to the input unit 11 as an object of maintenance in the step S3 (step S3: NO), the control unit 9 recognizes the presence of an error. In this case, the control unit 9 waits without driving the main movement mechanism 813 and the subsidiary movement mechanism 815 of the first head unit 35a. Further, the control unit 9 displays an error message on a display (not shown) or the like provided in the input unit 11, or generates an alarm or the like, to perform error notification (step S9).

Specifically, when it is detected on the basis of the first detection signal received from the first detection unit 45a, that the first head unit 35a has moved from the first driving position Pia to the first maintenance position Poa while the first input signal is not received from the input unit 11, the control unit 9 of the present preferred embodiment recognizes the presence of an error. Then, the control unit 9 waits while keeping the ink discharge surface 161 (first ink discharge surface) of each discharge head 811 of the first head unit 35a in a “capped state” without performing control of the main movement mechanism 813 and the subsidiary movement mechanism 815 of the first head unit 35a. Meanwhile, when it is detected on the basis of the second detection signal received from the second detection unit 45b, that the second head unit 35b has moved from the second driving position Pib to the second maintenance position Pob while the second input signal is not received from the input unit 11, the control unit 9 of the present preferred embodiment recognizes the presence of an error. Then, the control unit 9 waits while keeping the ink discharge surface 161 (second ink discharge surface) of each discharge head 811 of the second head unit 35b in a “capped state” without performing control of the main movement mechanism 813 and the subsidiary movement mechanism 815 of the second head unit 35b. With this configuration, in a case in which the head unit 35 that is not scheduled to be pulled out to the outside space is pulled out, the operator can recognize the presence of an error and thus can discontinue the rest of the work.

### 3. Modifications

Hereinabove, the present preferred embodiment of the present invention has been described, but the present invention is not limited to the above-described preferred embodiment.

In the above-described preferred embodiment, the subsidiary movement mechanism 815 of the head unit 35 is driven, and the head holding plate 814 and each discharge head 811 are moved up/down. Thus, switching of the ink discharge surface 161 of each discharge head 811 between a “capped state” and a “decapped state” is achieved. As an alternative to upward/downward movement of each discharge head 811 of the head unit 35, the cap 812 may be moved up/down in order to achieve switching of the ink discharge surface 161 of each discharge head 811 between a “capped state” and a “decapped state”

In the above-described preferred embodiment, by driving of the subsidiary movement mechanism 815 of the head unit 35, switching of the ink discharge surface 161 of each discharge head 811 between a “capped state” and a “decapped state” is achieved. Further, by driving of the main movement mechanism 813, the cap 812 is moved along the X direction. As a result of this, the ink discharge surface 161 of each discharge head 811 is entirely exposed from the cap 812. However, the main movement mechanism 813 may be omitted on condition that the operator can make full access to the ink discharge surface 161 and perform various kinds of maintenance work only by changing a distance between the ink discharge surface 161 and the cap 812 along the Z direction.

In the above-described preferred embodiment, the operator gives a command via the input unit 11 to the effect that switching of the ink discharge surface 161 of each discharge head 811 between a “capped state” and a “decapped state” by driving of the subsidiary movement mechanism 815 of the head unit 35, and movement of the cap 812 in a “decapped state” between the facing position P1 and the receding position P2 are successively performed. Alternatively, switching of the ink discharge surface 161 between a “capped state” and a “decapped state” and movement of the cap 812 between the facing position P1 and the receding position P2 may be individually requested. That is, the operator may be allowed to give a command for switching the ink discharge surface 161 from a “capped state” to a “decapped state” and a command for moving the cap 812 to the receding position P2 after decapping, individually, via the input unit 11.

Likewise, the operator may be allowed to give a command for moving the cap 812 of the head unit 35 from the receding position P2 to the facing position P1 and a command to the cap 812 at the facing position P1 for placing the ink discharge surface 161 of each discharge head 811 into a “capped state”, individually, via the input unit 11.

Further, the respective elements described in the above-described embodiment may be appropriately combined unless contradiction occurs.

While the invention has been shown and described in detail, the foregoing description is in all aspects illustrative and not restrictive. It is therefore understood that numerous modifications and variations can be devised without departing from the scope of the invention.

What is claimed is:

1. An inkjet printing apparatus that performs printing on a printing medium by an inkjet method, comprising:
an apparatus casing:
a first head unit including a first discharge head having a first ink discharge surface in which a first discharge port facing down, through which first ink is discharged, is formed, a first cap configured to cap the first ink discharge surface, and a first movement mechanism configured to switch the first ink discharge surface between a capped state in which the first ink discharge surface is isolated from an outside atmosphere with the first cap and a decapped state in which the capped state is canceled;
a second head unit including a second discharge head having a second discharge surface in which a second discharge port facing down, through which second ink is discharged, is formed, a second cap configured to cap the second ink discharge surface, and a second movement mechanism configured to switch the second ink discharge surface between a capped state in which the second ink discharge surface is isolated from the outside atmosphere with the second cap and a decapped state in which the capped state is canceled;
a first slider supporting the first head unit such that the first head unit is slidable between a first driving position in an inside space of the apparatus casing and a first maintenance position in an outside space of the apparatus casing;
a second slider that is provided separately from the first slider and supports the second head unit such that the second head unit is slidable between a second driving position in the inside space of the apparatus casing and a second maintenance position in the outside space of the apparatus casing;
a first detection unit configured to detect movement of the first head unit between the first driving position and the first maintenance position and output a first detection signal;
a second detection unit configured to detect movement of the second head unit between the second driving position and the second maintenance position and output a second detection signal;
an input unit configured to receive a first command including a command for switching the first ink discharge surface from the capped state to the decapped state and output a first input signal upon receipt of the first command, the input unit being configured to receive a second command including a command for switching the second ink discharge surface from the capped state to the decapped state and output a second input signal upon receipt of the second command; and
a control unit electrically connected to the first discharge head, the first movement mechanism, the first detection unit, the second discharge head, the second movement mechanism, the second detection unit, and the input unit, wherein
the control unit is capable of individually performing
a step a) of controlling the first movement mechanism so as to switch the first ink discharge surface from the capped state to the decapped state after elapse of a first predetermined time period when it is detected on the basis of the first detection signal received from the first detection unit, that the first head unit has moved from the first driving position to the first maintenance position while the first input signal has been received from the input unit, and
a step b) of controlling the second movement mechanism so as to switch the second ink discharge surface from the capped state to the decapped state after elapse of a second predetermined time period when it is detected on the basis of the second detection signal received from the second detection unit, that the second head unit has moved from the second driving position to the second maintenance position while the second input signal has been received from the input unit.

2. The inkjet printing apparatus according to claim 1, wherein
after the step a), the control unit controls the first movement mechanism so as to switch the first ink discharge surface from the decapped state to the capped state when it is detected on the basis of the first detection signal further received from the first detection unit, that the first head unit has moved from the first maintenance position to the first driving position, and
after the step b), the control unit controls the second movement mechanism so as to switch the second ink discharge surface from the decapped state to the capped state when it is detected on the basis of the second detection signal further received from the second detection unit, that the second head unit has moved from the second maintenance position to the second driving position.

3. The inkjet printing apparatus according to claim 1, wherein
the control unit recognizes presence of an error and waits while keeping the first ink discharge surface in the capped state when it is detected on the basis of the first detection signal received from the first detection unit, that the first head unit has moved from the first driving position to the first maintenance position while the first input signal is not received from the input unit, and
the control unit recognizes presence of an error and waits while keeping the second ink discharge surface in the capped state when it is detected on the basis of the second detection signal received from the second detection unit, that the second head unit has moved from the second driving position to the second maintenance position while the second input signal is not received from the input unit.

4. The inkjet printing apparatus according to claim 1, further comprising:
a first circulation path including a first supply tank in which the first ink supplied to the first discharge head is stored, a first collecting tank in which the first ink collected from the first discharge head is stored, and a first feedback pipe connecting the first collecting tank and the first supply tank;
a first circulation pump interposed in the first feedback pipe, the first circulation pump being configured to deliver the first ink from the first collecting tank to the first supply tank via the first feedback pipe;
a second circulation path including a second supply tank in which the second ink supplied to the second discharge head is stored, a second collecting tank in which the second ink collected from the second discharge head is stored, and a second feedback pipe connecting the second collecting tank and the second supply tank; and
a second circulation pump interposed in the second feedback pipe, the second circulation pump being configured to deliver the second ink from the second collecting tank to the second supply tank via the second feedback pipe, wherein
the control unit is further electrically connected to the first circulation pump and the second circulation pump,
the control unit stops driving the first circulation pump when it is detected that the first head unit has moved from the first driving position to the first maintenance position, and
the control unit stops driving the second circulation pump when it is detected that the second head unit has moved from the second driving position to the second maintenance position.
